(19) United States
(12) Patent Application Publication
(10) Pub. No.: US 2002/0012441 A1
(43) Pub. Date: Jan. 31, 2002

(54) Body set type speaker unit

(75) Inventors: Katsuya Matsunaga, Yamato-shi (JP); Takashi Segawa, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/916,027

(22) Filed: Jul. 26, 2001

(30) Foreign Application Priority Data
Jul. 27, 2000 (JP) 2000-226413

(51) Int. Cl. H04R 25/00; H04M 1/00

(52) U.S. Cl. 381/381; 381/370; 381/376; 381/379; 379/433.01

(57) ABSTRACT

An ear-hanging type speakerphone unit that allows users to listen to both sounds from the speaker and sounds from the outside environment, while suppressing leakage of the sounds emanating from the speaker to the outside environment, is provide for. A directional speaker is adjustably held with its speaker face being, for example, approximately 1 to 2 cm. away from the opening of an external auditory miatus, such that an open air space is formed between the speaker face and the opening of the miatus.

### BACKGROUND OF THE INVENTION

1. Field of the Invention

The present invention relates to a body set type speaker unit that outputs sound reproduced from audio equipment, voice output from communication equipment, etc., and more particularly to a body set type speaker unit which allows users to listen to sound therefrom, while assuring continued hearing of the outside sound, concurrently.

2. Description of the Related Art

It is known that earphones and headphones are common devices used by many to listen to sound from a variety of electronic devices including but not limited to audio equipment, personal computers, communication equipment, cellular phones, etc. It is also generally recognized that the physical size of these devices often causes these devices to be readily visible. For instance, a person listening to the sound of a radio broadcast from a small radio with a built-in speaker, often places the radio receiving portion of the device in proximity to a convenient pocket of a user's article of clothing (e.g., a user's shirt pocket), resulting in both a casual observer and a user easily recognizing that a device is physically present in the user's clothing.

When certain other of these devices are used by a user, particularly with reference to devices utilizing earphones or headphones, one or more of the user's auditory canals is often blocked or “closed-off” from the outside environment by the physical presence of the earphone or speakerphone portion of the device such that the user is unable to hear or listen to sounds of the outside environment. As a result, the user of these types of devices is often only able to listen to the sound being produced from the speaker component of the device.

In contrast, where a user of a device having a built-in speaker is listening to sound from a speaker placed near to but not closing off his ear, such as near a breast pocket, hearing of the outside environmental sound is assured. However, in these types of devices having a built-in speaker, the quality and clarity of the sound produced from the speaker is often detrimentally affected due to the sound waves being scattered as a result of interference of sounds and noises present in the outside environment.

In other situations, a user may listen to the outside sound via one ear and sounds from a device via a single earphone placed on the other ear (i.e., a mono system). However, in these situations where a user's respective ears receive different sounds from different sources (e.g., such as the speaker sound in one ear and the outside sound in the other ear) the user often experiences a sense of incompatibility that often causes the auditory nerve to fatigue. In the situation where a user listens to speaker sounds in stereo, such that each ear has an earphone placed thereon to allow a user's ears to hear similar sounds from a common source, it is known that it is fairly difficult to listen to the outside sounds concurrently with the stereo sounds produced via the conventional earphones or headphones.

### SUMMARY OF THE INVENTION

An object of the present invention is to provide a body set type speaker apparatus which allows a user to listen to both the outside sound and the sound emanating from the speaker, while limiting the leakage of the sound emanating from the speaker to the outside environment.

A body set type speaker unit comprising a mounting member detachably mountable on a user, and a directional speaker having a speaker face which is positionable such that the face may be securely positioned at a predetermined distance away from a user's ear by a speaker hold member, wherein said speaker hold member securely positions said directional speaker at said predetermined distance away from a user's ear to form an air gap having a distance as between said ear and said face.

Although the term body set type speaker unit is typically a head set type, the expression “body set type” as used herein is defined to include but not be limited to a head set type, a face set type, a shoulder set type, a trunk set type, an arm set type, etc., wherein the terms “unit” and “apparatus” are intended to be used interchangeably without augmentation of definition. Provided a body set type speaker unit comprises a directional speaker having sufficient directivity, the speaker can prevent the leakage of the sound emanated from a speaker to the outside environment, so as to sufficiently suppress the interference of external noise (i.e., noise not emanating from the speaker) with the sound emanating from the speaker, even when the unit is at a predetermined distance away from the user's ear or auditory canal. However, the leakage of the speaker sound to the outside can be prevented regardless of a slight reduction in directivity, if the directional speaker is disposed as near to the user's ear as is possible, while assuring a formation of the external open space between the directional speaker and the ear. As used herein, the terms “ear hole” and “ear canal” are used interchangeably without reservation wherein each is defined to include, for example, the opening of an external auditory miatus.

The speaker sound (i.e., the sound emanating from a speaker) includes but is not limited to be: the sound reproduced by a record player from sound recorded on an optical disk (such as a CD, an MD, a DVD, etc.), IC memory, or other electronic or digital media; the broadcast sound output from a tuner for a radio, television, or other entertainment device; the sound output from a personal computer (PC) or other electronic device; the voice output from a portable telephone or communication equipment which occurs during conversion, and the like. The user includes PC operators, and respondents in support centers responding to inquiries about products or services received by telephone.

The body set type speaker unit usually “receives” these sounds by a conductive or radiated means such as wire or radio, respectively. However, in the case where the speaker unit is equipped integrally with a small tuner, a telephone, and communication equipment so that the directional speaker can output sound, a device for receiving an external signal by radio or wire can be omitted.

Since the external open space (a.k.a. an “air gap”) is formed between the ear and the directional speaker, the ear is not closed off from the outside and therefore the outside sound reaches the ear through the external open space. In other words, sound waves from the outside environment reach the miatus without being physically obstructed by the presence of a speaker or earphone device in direct contact with the ear. As a result, the user can listen to both the speaker sound and the outside sound, simultaneously. In addition, the directional speaker meets the directivity requirement (in which, when the speaker face is directed toward the ear hole of the user, a ratio, equivalent to that of the sound energy radiated from the speaker face to the ear hole in relation to the total sound energy radiated from the speaker face, is of a predetermined value or greater). This can effectively prevent the leakage of the speaker sound to the outside. Because hearing of the outside sound has been guaranteed, the user can set the body set type speaker unit to the user's body only when listening to a musical piece, or during telephone conversion, and the user can omit the operation of removing the body set speaker unit when not used, and listen to the speaker sound from the body set type speaker unit as necessary, while holding the speaker unit set to the user's body without interruption.

According to the body set type speaker unit of another aspect, the speaker hold member in the first body set type speaker unit holds the directional speaker so that a distance from the directional speaker to the user's ear can be adjusted.

As a distance from the directional speaker to the ear hole can be adjusted, the body set speaker unit can be used in conformity with the form or preference of the user. In addition, the user can make adjustments to a sound-volume ratio of the outside sound and the speaker sound by changing the air gap distance as measured between the directional speaker and the ear hole. Note that if the body set type speaker unit is equipped with volume adjustment means for adjusting the sound volume of the speaker sound, the user can adjust the sound-volume ratio of the speaker sound and the outside sound as appropriate, by operating the volume adjustment means.

According to the body set type speaker unit of another aspect, the speaker hold member in adjustably holds the directional speaker so that direction of the directional speaker can be adjusted.

Since the direction of the directional speaker can be adjusted, the body set speaker unit can be used in conformity with the form or preference of the user. In addition, the user can make adjustments to a sound-volume ratio of the outside sound and the speaker sound as appropriate, by changing the direction of the directional speaker.

According to the body set type speaker unit of another aspect, an audio signal which is output by the directional speaker may be used to generate sound, wherein the audio signal may be a signal that is received by conductive or wave transmission means. As an example, a conductive means may include a wire or other physically conductive device, whereas a wave transmission means may include a radio transmission, satellite transmission and the like.

According to the body set type speaker unit of another aspect, the unit may further comprise a bone-conduction type speaker for transmitting a sound having a frequency of a predetermined value or less to the user through a bone-conduction via contact with the user.

The expression “sound having a frequency of a predetermined value or less” as used herein is used to include but not be limited to sounds which are typically low in pitch. The predetermined value is, for example, about 250 Hz or less, and is preferably approximately 150 Hz or less. Since the distance that the low-pitched sound can reach is short when compared with a high-pitched sound, if the distance from the directional speaker to the user's ear hole becomes slightly longer, it would conceivably be difficult for the user to sufficiently listen to the low-pitched sound. In the present invention, this body set type speaker unit provides that the user can reliably listen to the low-pitched sound as the low-pitched sound is transmitted to the user by the bone-conduction type speaker when in contact with the user.

In the body set speaker unit of another aspect, the body set type speaker unit further comprises an urging member for generating an urging force of pressing the bone-conduction type speaker in contact with the user's body.

Preferably, the urging member comprises a compression coil spring separate and apart from the speaker hold member. In the alternative, it is also envisioned that the speaker hold member may be made from a member, which has a predetermined spring force, such as a plate spring, etc. In this case the speaker hold member also functions as the urging member.

In any of the aspects herein, the body set type speaker unit may further comprise a microphone for communication, recording of user's voice, etc.

Further, it is envisioned by the inventors that the present invention is not limited to an apparatus having only a single directional speaker; the present invention is preferably comprised of at least one directional speaker such that a preferred embodiment comprises two directional speakers wherein there is a directional speaker available for each ear of a user.

### BRIEF DESCRIPTION OF THE DRAWINGS

FIG. 1 is a schematic diagram showing an ear-hanging type speakerphone unit in the set state;

FIG. 2 is a rear view of the ear-hanging type speakerphone unit 10 shown together with a cross-section of an ear at a position of an external auditory miatus 18 along the anteroposterior axis;

FIG. 3 is a perspective view showing a glasses-attaching type speakerphone unit attached to glasses;

FIG. 4 is a schematic diagram showing a helmet type speakerphone unit;

FIG. 5 is a schematic diagram showing a cap type speakerphone unit; and

FIG. 6 is a perspective view showing a hair band type speakerphone unit.

### DETAILED DESCRIPTION OF THE INVENTION

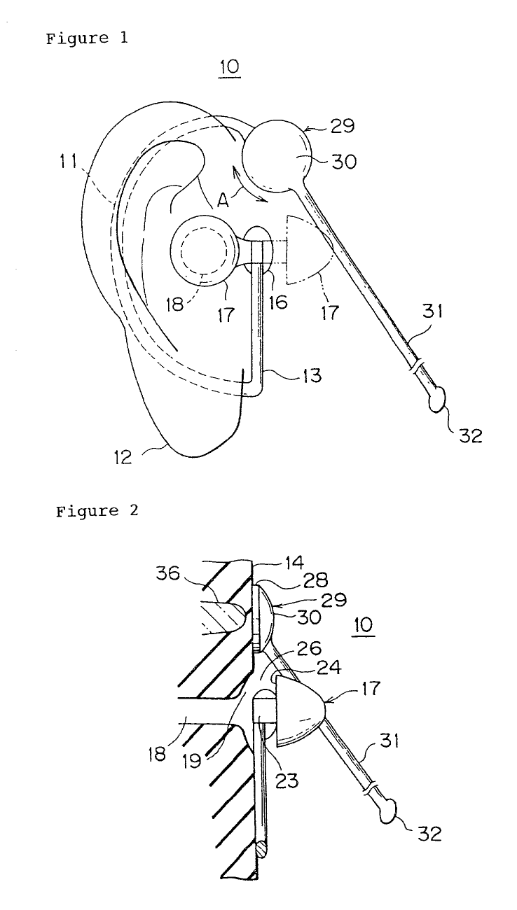

FIG. 1 shows an ear-hanging type speakerphone unit 10 in the set state; FIG. 2 is a rear view of the ear-hanging type speakerphone unit 10 shown together with a cross-section of an ear at a position of an external auditory miatus 18 along the anteroposterior axis. An ear hanging portion 11 is formed into a curved shape conforming to the contour of the rear side of the proximal portion of the concha of an ear 12 so it can be hung on the rear side of the proximal portion of the concha. A rising portion 13 rises upward from the lower end of the ear 12 in a vertical direction, the upper end reaching approximately the height of the external auditory miatus 18. A universal joint portion 16 is provided on the upper end portion of the rising portion 13. A stay 23 is coupled at one end thereof with the universal joint portion 16 so that it is free to rotate in a three-dimensional direction, and fixes an ultra directional speaker 17 at the other end. The ultra directional speaker 17 has a flat speaker face 24 and a bulged portion extending to the opposite side of the speaker face 24. The rotation of the stay 23 with respect to the universal joint portion 16 renders it possible to adjust the position of the ultra direction speaker 17 in the vertical, lateral, and fore-and-aft directions in a predetermined range and to adjust both a distance from the stay 23 to the external auditory miatus 18 and the direction of the stay 23. An opening 19 forms an opening (ear hole) through which the external auditory miatus 18 is connected with the outside, and gradually increases its diameter toward the outside.

The speaker face 24 is positioned, for example, 1 to 2 cm away from the circumferential edge of the opening 19 in the horizontal direction. For the directivity of the ultra directional speaker 17, a directional speaker is adopted in which, when the speaker face 24 is a predetermined distance away from the opening 19 and directed toward the opening 19, a ratio of the sound energy Eₐ radiated from the speaker face 24 to the opening 19 and the total energy Eₜ radiated from the speaker face 24 (Eₐ/Eₜ) is a sufficiently great value Eᵣ (near to 1) or greater than Eₐ/Eₜ (Eₐ/Eₜ>Eᵣ). The ultra directional speaker 17 may be any one of a variety of commercially-available microspeakers. Such microspeakers are normally about 20 mm or so in opening diameter and a few grams in weight. These microspeakers can also be provided with a reflector as necessary to further enhance directivity. An external open space 26 is formed between the opening 19 and the speaker face 24 so that the outside sound can be transmitted from the external open space 26 through the opening 19 and to the external auditory miatus 18.

A bone-conduction type speaker 29 is attached to the upper end portion of the ear-hanging portion 11 so it can contact a side face 14 of the user at a forward and obliquely upward position with respect to the universal joint portion 16. The bone-conduction type speaker 29 has a pressing portion 28, which is pressed against the side face 14, for outputting sound waves, and a housing portion 30 covering the opposite face of the pressing portion 28 from the side face 14 so it can freely rotate in the direction of arrow A with respect to the pressing portion 28. The upper end portion of the ear-hanging portion 11 is curved into a predetermined shape so that when the ear-hanging portion 11 is hung on the ear 12, a force of pressing the bone-conduction type speaker 29 against the side face 14 of the user will be developed by the restoring force of the curved shape. This causes the bone-conduction type speaker 29 to be pressed against the side face 14 with a predetermined pressing force and the sound waves from the bone-conduction type speaker 29 to be transmitted efficiently to a facial bone 36 directly under the side face 14. A plastically deformable tube 31 is secured at its upper end portion to the housing portion 30, and the user can plastically deform the tube 31 into an arbitrary shape with his fingers. A microphone 32 is secured at its lower end portion to the plastically deformable tube 31. The user plastically deforms the plastically deformable tube 31 to change the position of the microphone 32 so that the microphone 32 is near his mouth when using it and away from his mouth when not using. Note that the interior of the plastically deformable tube 31 is wired to transfer a signal input through the microphone 32.

While the ear-hanging type speakerphone unit 10 is equipped with only a single ultra directional speaker 17 for one ear, it may be equipped with two ultra directional speakers 17 for both ears. Even in the case of two ultra directional speakers 17 in total, the speakerphone unit 10 is normally equipped with a single bone-conduction type speaker 29 and a single microphone 32. Also, even in the case where the ear-hanging type speakerphone unit 10 is equipped with only a single bone-conduction type speaker 29, the contact position of the housing portion 30 with the user's body is not limited to the lateral center position on the body, but may be a position offset laterally from the lateral center position. The ear-hanging type speakerphone unit 10 is supplied with sounds by a predetermined sound source, which is not equipped in the speaker unit 10 itself. The sound source supplies sounds to the speakerphone unit 10 through the ultra directional speaker 17 and the bone-conduction type speaker 29 by radio or wire. A sound source like this may be a reproducer for an optical disk (such as a CD, an MD, a DVD, etc.) or IC memory, a tuner for a radio or television, a personal computer, a portable telephone, a desk telephone, etc. Although not shown, an on-off switch for sound output from the ultra directional speaker 17 or bone-conduction type speaker 29, and an adjustment portion for adjusting the volume of the sound output from the ultra directional speaker 17 or bone-conduction type speaker 29, in addition to those provided in a personal computer or record player, may be equipped in the ear-hanging speakerphone unit 10.

Sounds other than a low-pitched sound, for example, a sound of frequency is of 150 Hz or greater is radiated from the speaker face 24 of the ultra directional speaker 17 toward the external auditory miatus 18. Although the sound volume of the radiated sound is extremely small, the ultra directional speaker 17 has sufficient directivity, and in addition, the sound volume of the radiated sound arriving from the speaker face 24 at the external auditory miatus 18 is greater than a standard sound. As a result, the user can listen to the sound from the ultra directional speaker 17 without difficulty. On the other hand, since the external auditory miatus 18 is open to the outside through the opening 19 and the external open space 26 without being closed off, the outside sound reaches the external auditory miatus 18 via the external open space 26 and the opening 19 and is recognized by the user of the ear-hanging speakerphone unit 10. In this manner, the user can listen to the outside sound, while listening to the speaker sound from the ultra directional speaker 17. The user rotates the stay 23 on the center point of the universal joint portion 16 in the three-dimensional direction, thereby being able to adjust the direction of the speaker face 24, a distance from the speaker face 24 to the opening 19, and furthermore, the vertical, lateral, and fore-and-aft positions of the ultra directional speaker 17 in a predetermined range. This adjustment is beneficial in conforming the direction and position of the ultra directional speaker 17 to the form of the user and also makes a contribution to adjustments to the volume ratio between the outside sound and the speaker sound which the user hears. The sound of frequency of 150 Hz or less (hereinafter referred to as a “low-pitched sound”) is output from the bone-conduction type speaker 29 to the side face 14 by contact vibration. This low-pitched sound is transferred to a facial bone 36 directly under the side face 14 and recognized by the user. The bone-conduction type speaker 29 is pressed against the side face 14 with sufficient force by the spring force of the upper end portion of the ear-hanging portion 11. When using the microphone 32, the user plastically deforms the plastically deformable tube 31, thereby moving the microphone 32 to a position proper from the user's mouth.

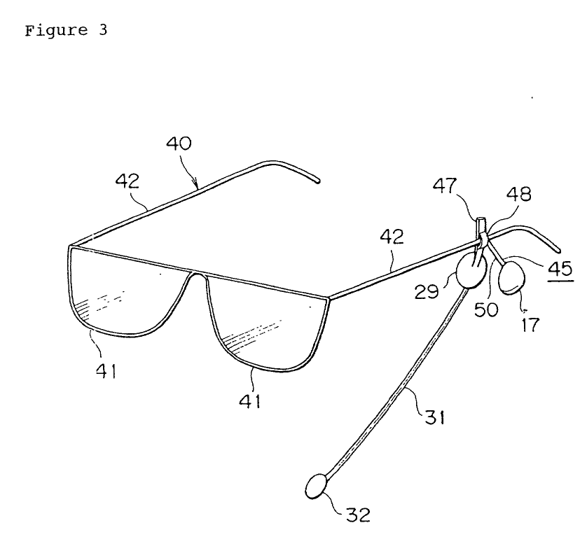

FIG. 3 shows a perspective view of a glasses-attaching type speakerphone unit 45 attached to glasses 40. In FIG. 3 and the figures thereafter, an ultra directional speaker 17, a bone-conduction type speaker 29, a plastically deformable tube 31, and a microphone 32 are the same structure as those in the ear-hanging type speakerphone unit 10 (FIGS. 1 and 2), so the same reference numerals as those of the ear-hanging type speakerphone unit 10 are applied. While the glasses-attaching type speakerphone unit 45 is equipped with only a single ultra directional speaker 17, it may be equipped with two ultra directional speakers 17 for both ears. Even in the case of two ultra directional speakers 17 in total, the speakerphone unit 45 is normally equipped with a single bone-conduction type speaker 29 and a single microphone 32. The glasses-attaching type speakerphone unit 45 is detachably attached, as appropriate, to the glasses 40 and is detachably set to the user's face through the glasses 40. The glasses 40 have right and left side frame portions 42, and right and left side frame portions 42 extending rearward from the outer ends of the right and left side frame portions 42. The glasses-attaching type speakerphone unit 45 has a mounting portion 47, which is in turn equipped at the outer face with a hook 48 that is hung on the rear end portion of the side frame portion 42. The position at which the hook 48 is hung on the side frame portion 42 may be any position on the side frame portion 42. A plastically deformable arm 50 projects obliquely downward from the mounting portion 47, the ultra directional speaker 17 being secured to the lower end portion of the plastically deformable arm 50. The user plastically deforms the plastically deformable arm 50 as appropriate, thereby adjusting the direction of the ultra directional speaker 17, a distance from the ultra directional speaker 17 to an external auditory miatus 18, and the vertical, lateral, and fore-and-aft positions of the ultra directional speaker 17. The lower end portion of the mounting portion 47 is curved toward the user_s face with respect to the upper end so that when the user puts the glasses 40 on his face, the bone-conduction type speaker 29 is pressed against a user's side face 14 with a predetermined pressing force. The plastically deformable tube 31 extends from the bone-conduction type speaker 29, the microphone 32 being secured to the lower end portion. Plastic deformation of the plastically deformable tube 31 can adjust the position of the microphone 32.

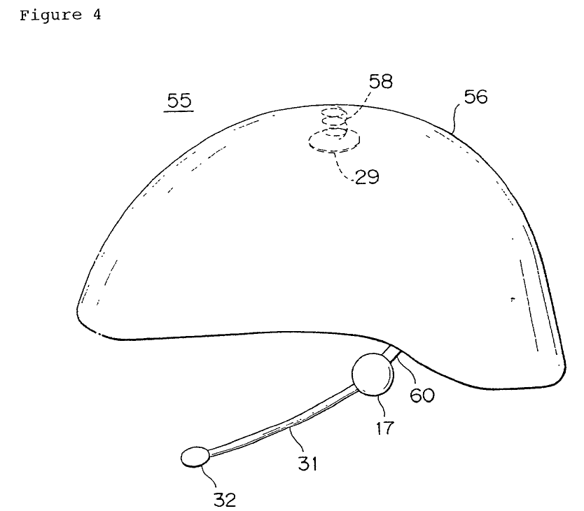

FIG. 4 shows a schematic diagram of a helmet type speakerphone unit 55. While this helmet type speakerphone unit 55 is used by a two-wheeled vehicle rider, the same structure is also applicable to helmets for factories, civil engineering works, and building sites. While the helmet type speakerphone unit 55 is equipped with only a single ultra directional speaker 17 for one ear, it may be equipped with two ultra directional speakers 17 for both ears. Even in the case of two ultra directional speakers 17 in total, the speakerphone unit 55 is normally equipped with a single bone-conduction type speaker 29 and a single microphone 32. A compression coil spring 58 is secured at its upper end to the top of the inner surface of a helmet 56 and tangles to its lower end. The bone-conduction type speaker 29 is secured to the lower end of the compression coil spring 58. In mounting the helmet 56 on the head portion of the user, bands (not shown) is tied under the chin. As a result, the helmet 56 is pressed against the head portion and the compression coil spring 58 is compressed, whereby bone-conduction type speaker 29 is pressed against the user_s head portion with a predetermined urging force. A stay 60 is secured at its upper end portion to the left lower end portion of the helmet 56 and protrudes downward by a predetermined length. Attached to the lower end portion of the stay 60 is the ultra directional speaker 17. The direction of the ultra directional speaker 17 and the distance from the ultra directional speaker 17 to the external auditory miatus 18 are adjusted by plastic deformation of the stay 60. A plastically deformable tube 31 is secured at its upper end portion to the ultra directional speaker 17 and extends downward from the ultra directional speaker 17, a microphone 32 being attached to the lower end portion.

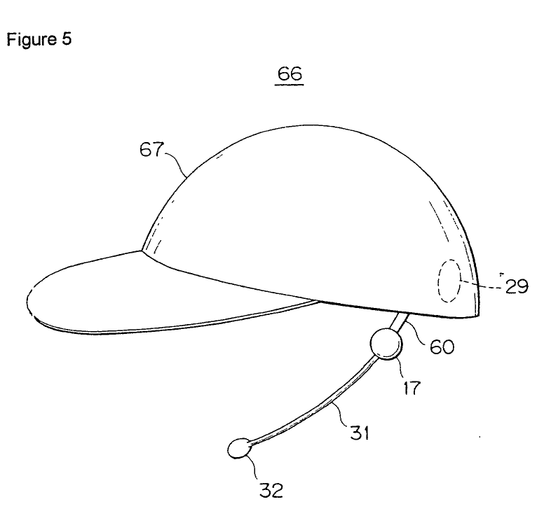

FIG. 5 shows a perspective view of a cap type speakerphone unit 66. While the cap type speakerphone unit 66 is equipped with only a single ultra directional speaker 17 for one ear, it may be equipped with two ultra directional speakers 17 for both ears. Even in the case of two ultra directional speakers 17 in total, the speakerphone unit 66 is normally equipped with a single bone-conduction type speaker 29 and a single microphone 32. A cap 67 is woven from cloth and consists of a peak portion and a head covering portion. The bone-conduction type speaker 29 is secured to the inner surface of the head covering portion of the cap 67, for example, the left inner surface. If the user wears the cap 67, the bone-conduction type speaker 29 is pressed against his head portion with a predetermined force. A stay 60 in this example is present on the same side of the bone-conduction type speaker 29 at the head covering portion of the cap 67. The stay 60 is secured at its upper end portion to the lower end portion of the head covering portion of the cap 67 and tangles from the cap 67 by a predetermined length. The ultra directional speaker 17 is attached to the lower end portion of the stay 60. Plastic deformation of the stay 60 renders it possible to adjust the vertical, lateral, and fore-and-aft positions of the speaker face 24, the direction of the speaker sound, and a distance from the speaker sound to the external auditory miatus 18. A plastically deformable tube 31 with a predetermined length is secured at its upper end portion to the ultra directional speaker 17, a microphone 32 being attached to the lower end portion.

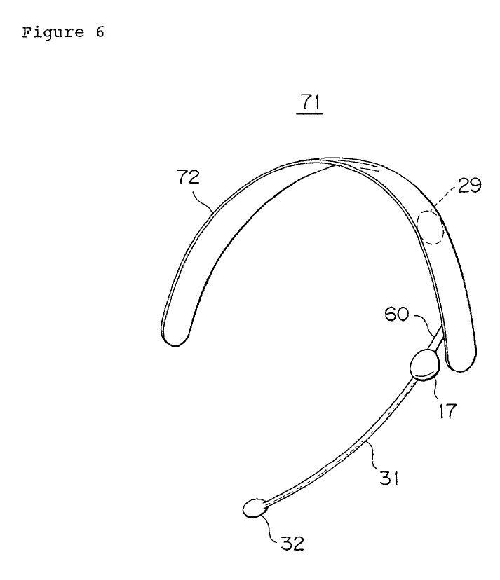

FIG. 6 shows a perspective view of a hair band type speakerphone unit 71. While the hair band type speakerphone unit 71 is equipped with only a single ultra directional speaker 17 for one ear, it may be equipped with two ultra directional speakers 17 for both ears. Even in the case of two ultra directional speakers 17 in total, the speakerphone unit 71 is normally equipped with a single bone-conduction type speaker 29 and a single microphone 32. A hair band 72 has an elastic force as a restoring force when expanded. The bone-conduction type speaker 29 is secured to a predetermined portion of the inner surface of the hair band 72. When the user wears the hair band 72, the bone-conduction type speaker 29 is pressed against the head portion of the user by the elastic force of the hair band 72, and low-pitched sounds are transmitted to a predetermined bone of the user_s head portion. A stay 60 is secured at its one end portion to the left end portion of the hair band 72 and projects forward in an obliquely downward direction. The ultra directional speaker 17 is attached to the other end portion of a stay 60. Plastic deformation of the stay 60 makes it possible to adjust the vertical, lateral, positions of the speaker face 24, the direction of the speaker sound, and a distance from the speaker sound to the external auditory miatus 18. A plastically deformable tube 31 with a predetermined length is secured at its upper end portion to the ultra directional speaker 17, a microphone 32 being attached to the lower end portion.

What is claimed is:

1. A body set type speaker unit comprising:
a mounting member detachably mountable on a user, and a directional speaker having a speaker face which is positionable such that the face may be securely positioned at a predetermined distance away from a user's ear by a speaker hold member, wherein said speaker hold member securely positions said directional speaker at said predetermined distance away from a user's ear to form an air gap having a distance as between said ear and said face.

2. The unit of claim 1 wherein the face is positioned in relation to the ear opening such that a ratio (Eᵣ) of the sound energy radiated from said face to the ear opening (Eₐ) in relation to the total energy radiated from the face (Eₜ) is of a value sufficiently approximating one or greater.

3. The unit of claim 2, wherein said speaker hold member is securable to said mounting member.

4. The unit of claim 2, wherein said speaker hold member provides for a user to adjustably and dimensionally position said directional speaker at a predetermined distance as between said face and said ear.

5. The unit according of claim 2, wherein said speaker outputs a received audio signal through via said face.

6. The unit of claim 5, wherein said audio signal is received by conductive or radiative means.

7. The unit of claim 2, further comprising a bone-conduction type speaker, for transmitting a sound of a frequency of a predetermined value or less to said user by placing said bone-conduction type speaker in contact with user.

8. The unit of claim 4, further comprising a bone-conduction type speaker, for transmitting a sound of a frequency of a predetermined value or less to said user by placing said bone-conduction type speaker in contact with user.

9. The unit of claim 8, further comprising an urging member for generating an urging force for placing said bone-conduction type speaker in contact with user.

10. The unit of claim 2, further comprising a microphone.

11. The unit of claim 8, further comprising a microphone.

12. The unit of claim 2, wherein said directional speaker comprises at least one directional speaker for a user.

13. The unit of claim 12, wherein said directional speaker comprises two directional speakers.

14. A set type speaker set comprising:
a mounting member detachably mountable on a user, and at least one directional speaker having a speaker face for assembly with said mounting member, wherein each of said speakers is positionable such that each of the faces may be securely positioned at a predetermined distance away from a user's ear by a speaker hold member when mounted, wherein said speaker hold member, when assembled, securely positions said directional speaker at said predetermined distance away from a user's ear to form an air gap having a distance as between said ear and said face, wherein said speaker is capable of outputting a received audio signal through via said face.

15. The set of claim 14, further comprising a bone-conduction type speaker for assembly with said mounting member.

16. The assembly of a mounting member detachably mountable on a user, and at least one directional speaker having a speaker face assembled with said mounting member, wherein each of said speakers is positionable such that each of the faces may be securely positioned at a predetermined distance away from a user's ear by a speaker hold member when mounted, wherein said speaker hold member, assembled to said mounting member, securely positions said directional speaker at said predetermined distance away from a user's ear to form an air gap having a distance as between said ear and said face, wherein said speaker is capable of outputting a received audio signal through via said face.

17. The assembled set of claim 16, further comprising a bone-conduction type speaker, for transmitting a sound of a frequency of a predetermined value or less to said user by placing said bone-conduction type speaker in contact with user.
